(19) United States
(12) Patent Application Publication
(10) Pub. No.: US 2014/0031954 A1
(43) Pub. Date: Jan. 30, 2014

(54) OPERATING UNIT FOR A CONSTRUCTION MACHINE AND METHOD FOR OPERATING THE OPERATING UNIT

(71) Applicant: BOMAG GmbH, Boppard (DE)

(72) Inventors: Michael Gerhardy, Fronhofen (DE); Thomas Haubrich, Godenroth (DE); Thomas Klein, Wehr (DE); Timo Löw, Boppard (DE); Hagen Stein, Kehrig (DE)

(21) Appl. No.: 13/949,558

(22) Filed: Jul. 24, 2013

(30) Foreign Application Priority Data
Jul. 24, 2012 (DE) 10 2012 014 655.8

(51) Int. Cl. G05B 15/02

(52) U.S. Cl. CPC G05B 15/02
USPC 700/19; 700/83; 700/57

(57) ABSTRACT

An operating unit for a construction machine, wherein the operating unit is attached to the construction machine so it can be folded or lowered. The operating unit has a touch screen for displaying and inputting. The selection and/or the arrangement and/or the display size of the information panels (14,14′,14″) and the operating panels (15,15′,15″) of the touch screen occurs in a situation-dependent manner.

### CROSS-REFERENCE TO RELATED APPLICATIONS

The present application claims priority under 35 U.S.C. §119 of German Patent Application No. 10 2012 014 655.8, filed Jul. 24, 2012, the disclosure of which is hereby incorporated herein by reference in its entirety.

### FIELD OF THE INVENTION

The present invention relates to an operating unit for a construction machine and a method for operating the operating unit, wherein the operating unit has a touch screen for displaying and inputting information.

### BACKGROUND OF THE INVENTION

Generic construction machines include, in particular, all mobile machines for traffic route construction and also earthmoving and landfill construction. Typical machines of this type are road milling machines, road pavers, recyclers, stabilizers, surface miners, compaction rollers, earth and waste compactors, gritting vehicles, diggers, caterpillars, and graders.

A generic construction machine comprises a machine frame and a chassis. The functional units of the chassis which are in contact with the supporting surface will hereafter be designated as driving elements. Typical driving elements are accordingly, for example, wheels, track mechanisms, rollers (drums), etc. The construction machines comprised here also have a working unit which is used for carrying out the specific construction machine function. In the case of a road milling machine, the working unit is a milling rotor, for example, and in the case of a compaction roller, it is an exciter for generating vibrations of the drum, for example.

An operator station is provided for the operator of such a construction machine, at which all operating panels and operating displays are provided. In particular, in the case of mobile and self-propelled construction machines, there are various operating modes such as, for example, transport operation, in which the construction machine only changes location, and various working modes, in which the construction machine carries out its intended work. Specific operating displays are to be observed by the operator and different operating functions are to be executed in the different working modes.

One operator station of this type for crane systems and heavy construction machines is described in DE 43 08 556 A1. In the access region of the operating person, it comprises an operating unit having a monitor. A display screen is provided, which is arranged so it is pivotable around multiple axes and can be inclined, and therefore can be adjusted so it is free of glare under all operating conditions. This display screen can be lowered or removed for nonuse. This is also to serve for protection from misuse or vandalism. However, the solution proposed in the publication has a very complex design and occupies a very large amount of space.

Furthermore, an operating unit for a gritting vehicle is known from U.S. 2008/0094374 A1. It comprises a touch screen for inputting information and for displaying information in different colors.

### SUMMARY OF THE INVENTION

It is the object of the present invention to provide an improved operating unit for a construction machine which offers sufficient vandalism protection, and to fundamentally improve the operating friendliness of construction machines.

According to a first aspect, the present invention relates to an operating unit for a construction machine, wherein the operating unit is attached to the construction machine so it can be folded or lowered, characterized in that the operating unit has a touch screen for displaying and inputting information, and the display of information panels and/or the operating panels is performed in a situation-related manner. The folding or lowering capability has the consequence that the operating unit is not externally visible after the folding or lowering and thus offers less inducement for vandalism. Furthermore, locking is preferably provided in the folded or lowered state. If needed, the touch-sensitive touch screen can also be protected from damage or external hazard effects by folding or lowering. A touch screen is also designated as a touch display screen or as a sensor display screen. It is substantially smaller in comparison to the prior art and additionally unifies the functions of display and operation in one component. For these constructional reasons, it can be folded or lowered much easier. However, it also offers less space for the display per se, and therefore, when it comes to changing from a multipart display and operating unit to a one-piece operating unit having touch screen and corresponding multifunction, it is advisable to perform the display of information panels and operating panels in a situation-related manner so that all displays and inputs relevant in the respective situation can be performed even in the small space available.

The term “situation-related” is understood according to the present invention to mean that the display of the information and the operating panels is dependent on the operating mode of the construction machine. Therefore, the display of the information and/or the operating panels changes in the event of change of the operating mode in such a manner that the information and operating panels required for the relevant operating mode are displayed, while information and/or operating panels which are not necessary for this operating mode are not displayed.

One aspect of the present invention is, in particular, varying the display of the operating panels on the touch screen in a situation-dependent manner. In particular, the selection or the arrangement of the displayed operating panels can be changed depending on the operating situation of the construction machine. Alternatively or in combination therewith, the size of the displayed operating panels can be varied depending on the operating situation of the construction machine. By way of such a method, the heretofore not yet exploited possibilities of a touch screen can be made use of still further in the case of the employment for a construction machine, especially if the touch-sensitive touch screen represents the only operating unit for operation, with the possible exception of an ignition lock or an ON switch which is used when the operating unit is initially started.

“Different operating situations” of the construction machine are understood as those situational deviations which are defined by the states and current activities of the tools and working units of the construction machine. Thus, a working vibration roller induces a different operating state in comparison to a non-vibrating drum, or, in the case of a road milling machine, turning on a milling roller for coarse milling represents a different operating state than turning on the milling roller for fine milling, for example. Operating states can thus be defined via internal parameters, i.e., construction-machine-related parameters. The change to a different operating menu shown on the touch screen, which per se has no direct effect on tools and working units, does not change the operating situation of the construction machine, since the touch screen and other control units, considered in isolation, do not represent a tool or working unit in the prior art of the present invention.

For example, it can be provided that, in a specific operating mode, exclusively those operating panels are displayed which are relevant for this operating mode. Operating panels which are not relevant in this operating mode remain blanked out. Furthermore, the size of individual operating panels can also differ depending on the situation. For example, in a travel mode, a type of virtual gas lever for controlling the travel velocity can be shown enlarged when the parking brake has been disengaged. An operating panel which relates to a rather unimportant operating command in travel operation can be dimensioned substantially smaller. Furthermore, of course, the virtual gas pedal lever can also be positioned substantially more centrally when the vehicle is moved. In contrast, when the parking brake is activated, for example, operating panels for actuating the working device, e.g., a drum for compacting the supporting surface, a conveyor device, or a milling roller, can be placed at a prominent point on the touch screen.

The present invention allows the space on the touch screen to be used as effectively as possible, with all currently relevant operating panels being displayed even on a minimum size touch screen. The arrangement of a plurality of, in particular, mechanical operating panels can be dispensed with, so that the susceptibility to error of the machine is also substantially reduced. Furthermore, the method offers the possibility that the operating concept can be continuously updated, simply by downloading a software update, in particular, from the manufacturer. The operating unit can therefore be adapted easily to new requirements.

Such an operating unit is preferably used at at least two different operating positions for operating the construction machine. Depending on the operating position of the operating unit, the selection, arrangement, or the display size of operating panels is varied. The operating unit is thus removably attached to the construction machine, and can be attached, for example, in a position on the left in the cab or in a position on the right in the cab. Another possibility would also be a position outside the cab, of course, for example, laterally on the housing, so that actuation from outside the machine is also possible. The connection between the construction machine and the operating unit can be both wireless and also wired, with, in particular, at least one positionally defined, i.e., one positionally fixedly predefined operating position being provided according to the present invention. An operating position can be positionally defined by a mount, in which the operating unit can be accommodated on the construction machine.

The advantage thereof resides in the fact that the display of the operating panels is varied depending on the occupied operating position. For example, operating panels are only significant in one special operating position, but are not in another. If, for example, it is required because of legal guidelines that the operating person is always located in the cab during the travel of the construction machine, and not outside the cab, the “travel operating elements” are only displayed when an operating position located inside the cab is occupied.

It is preferably automatically recognized in which operating position the operating unit is located. This can be performed with the aid of wiring or a plug connection, for example, in particular, by providing a contact switch in plug positions. Alternatively, this can also be performed in a wireless manner, e.g., by using RFID chips or other contactless identification possibilities. Alternatively, the operating position can also be determined exclusively by the type of connection. Thus, an existing Bluetooth connection can indicate that a positionally flexible operating position (not defined in greater detail) is occupied.

According to a further preferred embodiment, the operating unit can be connected to at least two separate construction machines for operating the respective construction machine. The selection, arrangement, or display size of operating panels is varied depending on the connected construction machine. The same statements made above for the operating position also apply, of course, if the operating unit is now used for another construction machine. It is obvious that other construction machines, in particular, those of different types, require different operating panels and also need different display elements for outputting information. The operating unit independently recognizes the respective construction machine to which it is connected, and automatically adapts the display of the operating panels to the specific operating situation.

The advantage is that the operating units are now no longer machine-related; the method according to the present invention allows the operating panels to now be person-related. This means that an operating person can have a type of personalized operating unit which he or she can use for operating a great variety of construction machines. The operating person can set the fundamental properties of the operating unit himself, for example, the preferred font size, the brightness, or color preferences. The properties of the operating unit specific to a construction machine are always automatically adapted, however, as soon as the operating unit is connected to another construction machine. The connection between the operating unit and the respective construction machine can be both wireless and also wired here. The operating position can be, on the one hand, an undefined position “somewhere” near the construction machine, i.e., wireless; on the other hand, the operating position can also be specifically positionally defined by a plug position or the like.

Furthermore, the present invention also comprises a construction machine which comprises an operating unit of the above-mentioned type. The operating unit is removably connected to the construction machine and is connectable at multiple different operating positions to the construction machine. Means for recognizing the operating position are provided. However, at least one positionally fixed operating position is preferably always provided. Furthermore, the present invention relates to a group of at least two construction machines, which differ from one another, in particular, in type, wherein both construction machines can be operated by the same, identical operating unit.

### BRIEF DESCRIPTION OF THE DRAWINGS

The present invention will be explained in greater detail on the basis of an exemplary embodiment shown in the drawing. In the schematic figures:

FIG. 1 shows a side view of a mobile, self-propelled construction machine;

FIG. 2 shows a top view in partial section of the construction machine in a further schematic illustration having an operating unit in various operating positions;

FIG. 3 to FIG. 5 each show a perspective illustration of an operating unit; and

FIGS. 6A and 6B illustrate a folding mechanism of an operating unit.

### DETAILED DESCRIPTION OF THE INVENTION

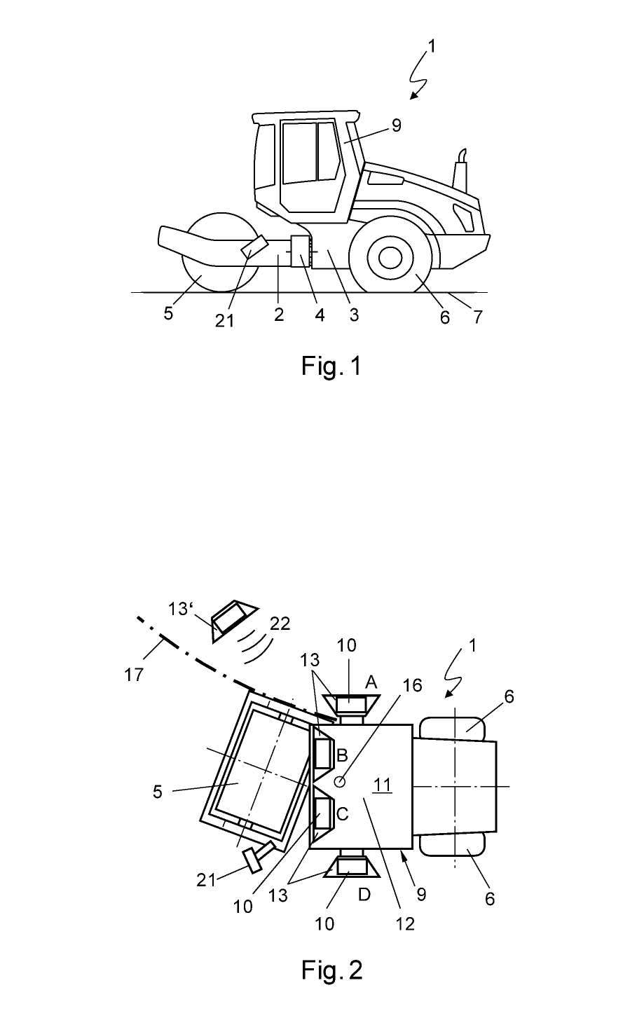

The construction machine 1 shown in FIG. 1 is, for example, a single-drum roller having a front wagon 2 and a rear wagon 3, which are connected to one another via an articulated swivel joint 4. The front wagon is provided with a drum 5 for vibration compaction of the supporting surface 7. The drum 5 forms a working unit of the construction machine 1, i.e., serves to perform the compaction work which is typical for a single drum roller. A pair of rubber-tired wheels 6 are located on the rear wagon 3. Furthermore, the construction machine is provided with a driver position 8 (FIG. 2), which is housed in a cab 9.

Solely as an example and as representative for all other monitoring, control, and regulating devices, which are typically provided on such a construction machine 1, an optical camera 21 is shown which is used for monitoring the working unit of the construction machine and the working result. Other variables which are typically monitored in such construction machines are, for example, fuel, water, oil pressure, compaction measured values of the supporting surface 7, and any type of other measurements with respect to the processed supporting surface, the geographic location of the construction machine 1, the travel velocity, the velocity selection, the drive of the working unit, the wear of the working unit, the speed of the drive and optionally of the working unit, operating hours, etc.

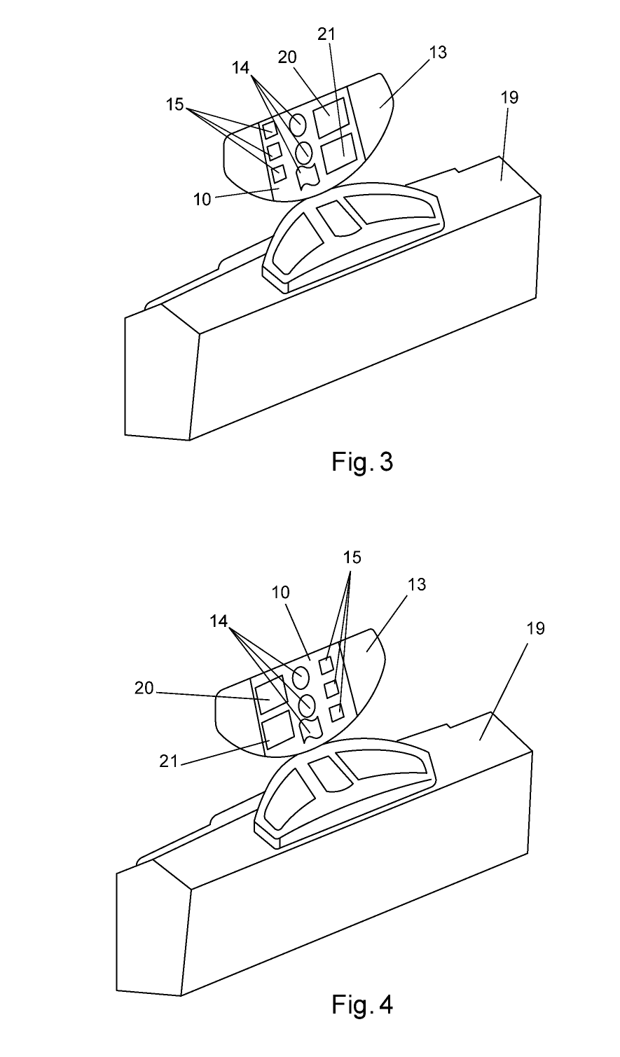

The construction machine 1 is operated in various operating modes. To simply change the location of the construction machine 1, for example, it is switched into a transport mode, in which it can travel at relatively high velocity, and in which the drum 5 does not perform any vibration work. To compact the supporting surface 7, the construction machine 1 can be driven with various operating modes, in which the drum is set into vibration, and in which the travel velocity of the construction machine 1 is typically relatively slow. The type of the vibration is set, for example, depending on the type of the supporting surface, the currently existing compaction, or the compaction to be achieved. The construction machine 1 is equipped with a work monitoring system, in this case a compaction monitoring system, using which the performed work/compaction is determined and documented and displayed together with further information on a touch screen 10 according to FIGS. 2 and 3.

In the top view of the construction machine 1 according to FIG. 2, the roof of the cab 9 is cut off, so that an operator position 12 implemented as a platform 11 is shown, which extends over the entire width of the construction machine 1 and on which an operating person (not shown) will stand. The operator position 12 is provided with an operating unit 13, which is shown in four different operating positions A, B, C, and D. The operating unit 13 is equipped with the touch screen 10, which is provided with information panels 14 and operating panels 15 (FIG. 3). Furthermore, a joystick 16 for controlling various functions of the construction machine 1 is provided at the operator position 12.

The operator position 12 can be equipped with a single operating unit 13, which can be arranged in a stationary manner at a predefined location, for example, in the operating position A, B, C, or D, or it can be variable in its operating position and can alternately be moved into one of the operating positions A, B, C, or D. In the case of large construction machines, multiple such operating units can also be provided at various operating positions A, B, C, or D. In the operating positions A and D, the operating unit 13 is held by means of an arm 18 outside the cab 9 or the platform 11. In the operating positions B and C within the cab 9 or the platform 11, the operating unit is held on a console 19 (FIG. 3). If a wireless connection 22 is provided between the construction machine 1 and a portable operating unit 13′, the construction machine 1 can therefore also be remote controlled in a remote control mode. In such an operating mode, only operating panels 15 which are required for remote operation of the construction machine 1 are displayed on the touch screen 10. Operating panels 15 for functions of the construction machine 1 for which remote operation is not to be possible are not displayed.

The operating position A, B, C, or D of the operating unit 13 is typically dependent on the current operating mode of the construction machine 1 and the conditions of the usage location. In FIG. 2, the construction machine is shown with a steering angle to the right, for example, wherein the drum 5 travels with its edge lying on the right in the travel direction along a predefined line 17, as is typically formed by a curb edge. For the operator to be able to closely monitor the edge of the drum 5, he will move to the relevant vehicle side. It is then advantageous if the operating unit 13 is also positioned on this vehicle side, whether outside the platform 11 in operating position A or inside the platform 11 in operating position B, so that the operator can read the information panels 14 of the touch screen 10 well and can easily reach the operating panels 15. This applies accordingly if the operator must stand on the left side or in the middle of the platform 11 and the operating unit 13 is located in the operating position C or D.

The information panels 14 and the operating panels 15 are displayed on the touch screen 10 in a situation-related manner, This means that the display is dependent on the current operating state, the current state of the construction site, and/or the current position of the operator on the platform 11. The information panels 14 display information which is tailored to the current operating state and/or the position of the operator. Similarly, the operating panels 15 relate to functions which relate to the current operating state and/or the position of the operator. If information and operating panels 14, 15 are required independently of the current situation, they remain unchanged.

If the construction machine 1 is in the transport mode, for example, the information panels 14 display the operating parameters of the construction machine 1 which are typical and important for transport travel, in particular, as follows: working unit in transport position, secondary drives shut down, etc. The operating panels 15 are selected in the transport mode in such a manner that typical and important functions of the construction machine 1 for the transport travel can be actuated and controlled, in particular, as follows: fast travel, slow travel, etc. For information which is not relevant to the transport mode, for example, measurement results with respect to a processing procedure, as in this case, for example, compaction measured values and specifications on the operation and wear of the working unit, are not displayed. Operating panels which do not relate to the transport mode are also not displayed, for example, turning the working unit on and off or turning specific work flows on and off, etc.

Typical displays in the information panels 14 and allocations of the operating panels 15 in a maintenance mode are, for example, “primary drive off/on”; “auxiliary drive off/on”. In a special mode “night operation” the proper function of all headlights and signal lamps is typically displayed and the actuation thereof is made possible via the operating panels 15.

Depending on the type of the construction machine 1, there are many operating modes which require different displays in the information panels 14 and operating panels 15 and different allocations of the operating panels 15. They can relate, for example, to the advance or the forward travel, to reversing operation, to switching on and off auxiliary assemblies, to the consumption or supply of auxiliary materials and additives, to the display of measurement results, to switching on and off measurement, monitoring, and control devices, etc.

The information panels 14 can be implemented in a known manner, for example, as analog or digital displays, as graphics, image representations, or a display screen for reproducing camera images, etc. The operating panels 15 can be represented in a known manner, for example, by icons, virtual buttons, slides, or levers, etc., which can be actuated by a corresponding touch by the operating person.

Multiple information panels 14 and/or operating panels 15 can be reproduced simultaneously on the touch screen 10. They can assume different sizes depending on the operating mode and/or by way of corresponding control by the operator and can differ in their location on the touch screen 10. In other words, the size, arrangement, and distribution of the individual information panels 14 and the operating panels can vary and/or be varied depending on the operating situation of the construction machine.

The changeover from a display of the operating panels 15 and information panels 14 can be performed automatically together with the changeover from one operating mode into the other, for example, also by actuating the joystick 16, or by the operator carrying out a changeover with the aid of an operating panel 15.

It is also advantageous that this described usage possibility of the operating unit 1 is not only limited to a single construction machine. The operating unit 13 can thus also be connected to another construction machine or used therewith, respectively. The operating unit 13 automatically determines in which operating position and/or to which construction machine it is connected and adapts the display of the touch screen 10 automatically.

FIGS. 3 and 4 illustrate the way in which the arrangement of the information panels 14 and the operating panels 15 is adapted in a situation-related manner to the position of the operator on the platform 11. The arrangement and distribution of the information panels 14, 20, 21 and the operating panels 15 is selected in FIG. 3 in accordance with the operating position C, for example, in which the operator is located on the left side of the platform 11. To make it easier to actuate the operating panels 15, they are therefore arranged on the left side of the touch screen 10. The larger information panels 21, which are therefore easier to read, are arranged in the furthest remote region, i.e., the right side of the touch screen 10. The information panels 15 can be analog or digital displays, the information panel 20 can be the television picture of the camera 20, and the information panel 21 can be a computer simulation of the processing state of the supporting surface 7.

The arrangement and distribution of the information panels 14, 20, 21 and the operating panels 15 in FIG. 4 corresponds to the operating position B, in which the operator is located on the right side of the platform 11. The arrangement of the information panels 14, 20, 21 and the operating panels 15 is laterally reversed in relation to the arrangement in the operating position C, so that the operating panels 15 are located closest to the right hand of the operator and the largest information panels are arranged farthest away from the operator. The changeover from one arrangement on the touch screen 10 to the other occurs automatically through a device for recognizing the position of the touch screen 10.

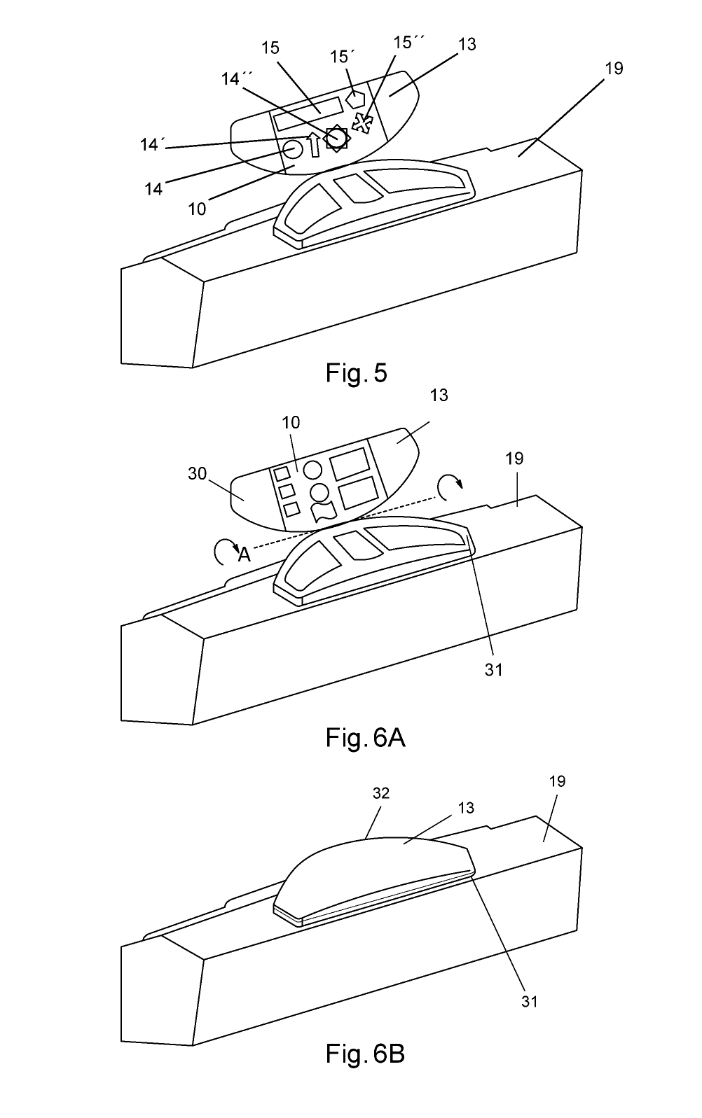

FIG. 5 shows the touch screen 10 having information panels 14, 14′, 14″ and operating panels 15, 15′, 15″ which differ according to arrangement, size, and type from the touch screen 10 shown in FIGS. 3 and 4. This is to illustrate solely schematically the way in which the information panels 14, 14′, 14″ and operating panels 15, 15′, 15″ change and adapt to the respective situation depending on the working modes and operating positions.

The operating unit 13 can be folded over at the end of operation in such a manner that the touch screen 10 is protected from damage. It is thus possible to provide the operating unit 13 with the touch screen 10 in such a manner that the touch screen 10 is no longer recognizable at all as a touch screen 10 after the operating unit 13 is folded over, which avoids vandalism. Additionally or alternatively, it is possible to lower the operating unit 13 having the touch screen, so that the view of an observer only falls on an inconspicuous, substantially level surface. It is also possible to provide locking, which can be activated after the folding over and/or lowering to protect from vandalism, theft, or unauthorized use. The above-mentioned embodiments of the folding over and/or lowering may be implemented in a very simple manner because of the comparatively small dimensions and the unity of the operating unit 13 having touch screen 10.

FIGS. 6A and 6B illustrate examples of a folding mechanism for an operating unit 13. FIG. 6A shows an extended state. In this state, the inner side 30 of the operating unit 13 having the touch screen can be seen and accordingly can also be operated. For folding, the operating unit 13 is pivoted about the pivot axis A, and the operating unit 13 comes to rest on the counter element 31 of the console 19. This advantageously occurs in such a manner that the comparatively sensitive touch screen 10 does not disadvantageously come into contact with the counter element 31 or problematic pressure is exerted thereon; the contact surface can be designed accordingly. The folded state of the operating unit is shown in FIG. 6B. An observer only sees the inconspicuous outer side or rear side 32 of the operating unit 13.

While the present invention has been illustrated by description of various embodiments and while those embodiments have been described in considerable detail, it is not the intention of Applicant to restrict or in any way limit the scope of the appended claims to such details. Additional advantages and modifications will readily appear to those skilled in the art. The invention in its broader aspects is therefore not limited to the specific details and illustrative examples shown and described. Accordingly, departures may be made from such details without departing from the spirit or scope of Applicants' invention.

What is claimed is:

1. An operating unit for a construction machine, wherein the operating unit is attached to the construction machine so it can be folded or lowered, wherein the operating unit has a touch screen for displaying and inputting information, and the display of information panels and/or the operating panels is performed in a situation-related manner.

2. The operating unit according to claim 1, wherein the selection and/or the arrangement and/or the display size of the displayed information panels and/or operating panels varies depending on the operating situation of the construction machine.

3. The operating unit according to claim 1, wherein the operating unit is usable at at least two different operating positions for operating the construction machine, and the selection, arrangement, and/or display size of operating panels is different depending on the operating position.

4. The operating unit according to claim 1, wherein means are provided for automatic recognition of the operating position, and the display of the information panels and/or the operating panels is controlled by the means with respect to the type, location on the touch screen, and/or size of the information panels and/or the operating panels.

5. The operating unit according to claim 1, wherein the operating unit can be connected to at least two separate construction machines for operating the respective construction machine, and the selection, arrangement, and/or display size of the information panels and the operating panels on the touch screen is adapted depending on the connected construction machine.

6. A construction machine comprising an operating unit according to claim 1.

7. The construction machine according to claim 6, wherein the construction machine comprises multiple positionally defined operating positions, at which the operating unit can be mechanically attached and functionally connected to the construction machine.

8. A method for operating the operating unit according to claim 1, wherein the display of information panels and/or the operating panels is performed in a situation-related manner.

9. The method for operating the operating unit according to claim 8, wherein a selection and/or arrangement and/or display size of the displayed information panels and/or operating panels varies depending on the operating situation of the construction machine.
